(19) United States
(12) Patent Application Publication
(10) Pub. No.: US 2007/0243844 A1
(43) Pub. Date: Oct. 18, 2007

(54) Flexible optical illumination system

(75) Inventors: Robert Cunningham, Plano, TX (US); Steven O. Dunford, Lewisville, TX (US); Jaakko Nousiainen, Marttila (FI); Ramin Vatanparast, Irving, TX (US)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 11/401,897

(22) Filed: Apr. 12, 2006

(51) Int. Cl. H04B 1/06

(52) U.S. Cl. 455/255

(57) ABSTRACT

A flexible optical illumination system may be used to illuminate components or areas of an electronic device such as mobile and portable communication devices. The flexible lightguide may manipulate and channel light selectively throughout an electronic assembly providing illumination for selective areas or an entire device. The lightguide may further include various filters and components for modifying, detecting and processing light and characteristics thereof. A flexible lightguide may be created from numerous optically transparent materials and processes such as film lamination, adhesive binding and molding. The lightguide may be created by a process that combines the manufacturing and assembly of the lightguide with the manufacturing and assembly of other components of the device. The lightguide may further be integrated into various mechanical or electronic components. The illumination system may also be used in different applications including decoration, illumination, alarms, message transfer and data transfer.

### FIELD OF THE INVENTION

The invention relates generally to a method and a system for providing illumination to components of an electronic. Specifically, the invention relates to the formation of a flexible optical lightguide for providing 2D and 3D illumination to components of an electronic assembly and/or the entire assembly.

### BACKGROUND OF THE INVENTION

For both aesthetic and functional reasons, illumination has become an expected feature of electronic devices such as mobile phones, remote controls, miniaturized PC and personal data assistants (PDA). Many electronic devices use illuminated components to indicate a status of the device while other components such as an antenna on a mobile telephone might be illuminated for decorative purposes. In one example, mobile telephone users often attempt to make calls in poorly lit areas and must make several attempts. As such, illuminated keypads have become popular for resolving such issues. Another component of electronic devices that is often illuminated is the display screen. The display screen of many devices such as mobile communication devices and remote controls are often backlit to aid a user in viewing the displayed information.

In order to supply desired illumination, electronic devices often implement multiple light emitting sources and one or more lightguides in order to disperse generated light. These lightguides are often planar and produced as separate rigid components prior to assembly. Accordingly, such lightguides must conform to relatively strict manufacturing tolerances so that the lightguide will fit into the assembled product. Furthermore, rigid lightguides tend to have substantial size impacts on the electronic devices in which they are used. For example, the size of a rigid lightguide often limits the degree to which the size of the end product (e.g., mobile phone) can be reduced. The inflexibility of rigid lightguides also restricts manufacturers from implementing various configurations when designing electronic devices. For example, a lightguide may be unable to bend around the edge of an electronic device, thus preventing the illumination of components on the back or front of the device. Additionally, multiple light emitting sources must often be used due to the inability of a single light emitting source to provide illumination to all the desired components and to multiple surfaces of a device. The need for additional light emitting sources further increases the power consumption of electronic devices. In mobile devices where battery power is at a premium, the addition of a lighting device may significantly decrease the battery life.

### SUMMARY OF THE INVENTION

In at least some embodiments, a non-rigid or flexible lightguide is used to distribute light in an electronic device. Using such a system or arrangement, a single flexible (i.e., non-rigid) illumination layer may be used to illuminate multiple components and multiple surfaces of an electronic assembly. For example, a single light source may be used to illuminate a front keypad and a rear keypad through a single flexible lightguide. In particular, a single flexible lightguide may guide and/or bend light around edges and corners of a device or assembly. The illumination layer may be constructed of a thin flexible material such as a flexible polymer or resin. The flexible illumination layer provides a flexible light conduit that is able to bend around edges and/or conform to the shape or position of one or more structures of a mating surface or device chassis. For example, a circuit board may include multiple protrusions or recesses. A flexible lightguide or illumination layer is conformable to these aspects of the circuit board by, for example, filling in the recesses. In addition, the flexible illumination layer may also provide a bonding mechanism to attach or mate various components of an electronic assembly. Such bonding mechanisms may consist of an optical adhesive in film or liquid form. The flexible illumination layer further consists of areas of illumination and non-illumination to direct light to regions where illumination is needed. These areas may be defined by regions where light is diffracted or allowed to escape in contrast to regions where light is restricted to the illumination layer.

In one or more embodiments, the illumination layer or lightguide may include one or more components to detect and/or alter one or more characteristics of emitted light. Such components may include wavelength division multiplexing (WDM) filters that may separate out light of different wavelengths (i.e., colors). Using a WDM filter, energy from a red LED may pass through one direction in the multiplexer while energy from a green light source may be filtered out or redirected. Such a feature may further be utilized to detect differing types or sources of light. RGB LEDs may also be used to transfer lights with different wavelengths. The differentiation of types or sources of light may be used to further activate various functions or processes via differing photodiodes or detectors. For example, if the natural lighting (i.e., from the sun) reaches a certain threshold, a photo-sensor embedded in the lightguide may activate a process that displayed a “GO HOME” message on the display screen of an electronic device. The lighting system may further be used to transfer information, data, and/or alarms.

In yet another aspect, the manufacturing of a flexible lightguide may be integrated with the overall assembly process and thus reduce manufacturing and assembly time and costs. For example, the lightguide may be applied as a liquid adhesive that both forms the flexible lightguide as well as bonds the multiple components of the electronic assembly together. The lightguide may be implemented for either data transfer processes or for decorative purposes.

### BRIEF DESCRIPTION OF THE DRAWINGS

The present invention is illustrated by way of example and not by limitation in the accompanying figures in which like reference numerals indicate similar elements and in which:

FIG. 1 illustrates multiple layers of a mobile communication device according to an illustrative embodiment.

FIGS. 2A, 2B and 2C illustrate multiple views of an electronic assembly having various depressions and extensions according to an illustrative embodiment.

FIGS. 2D and 2E illustrate cross-sections of alternative illustrative embodiments of the electronic assembly shown in FIG. 2A.

FIG. 3 illustrates an electronic device having a lightguide for illuminating user interface and display portions according to an illustrative embodiment.

FIG. 4A illustrates a dual-layer lightguide with multiple light sources and refractive structures according to an illustrative embodiment.

FIG. 4B illustrates the redirection of an emitted light from a first surface of a device to a second surface of the device using a non-rigid flexible lightguide.

FIGS. 5A, 5B and 5C illustrate the effects of varying the bending angle of a lightguide on the angle of incidence of a light ray and total internal reflection.

FIGS. 6A and 6B illustrate top and side views of a lightguide implementing an optical filter and detection system according to an illustrative embodiment

FIG. 7 is a flowchart illustrating a method for initiating, via a lightguide, a warning system upon detection of a predefined condition according to an illustrative embodiment.

FIG. 8 illustrates a method for forming and applying a flexible lightguide according to an illustrative embodiment.

FIG. 9 is a flowchart illustrating a method for manufacturing and assembling a lightguide according to an illustrative embodiment.

FIG. 10 illustratse multiple applications of a non-rigid lightguide in portable devices according to one or more illustrative embodiments.

### DETAILED DESCRIPTION OF THE INVENTION

In the following description of various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention. Although various embodiments are described by reference to a mobile communication device (e.g., a mobile phone), this is only one example of a device in which various aspects of the invention may be implemented. Other examples include, but are not limited to, PDAs, remote controls, laptop computers and watches.

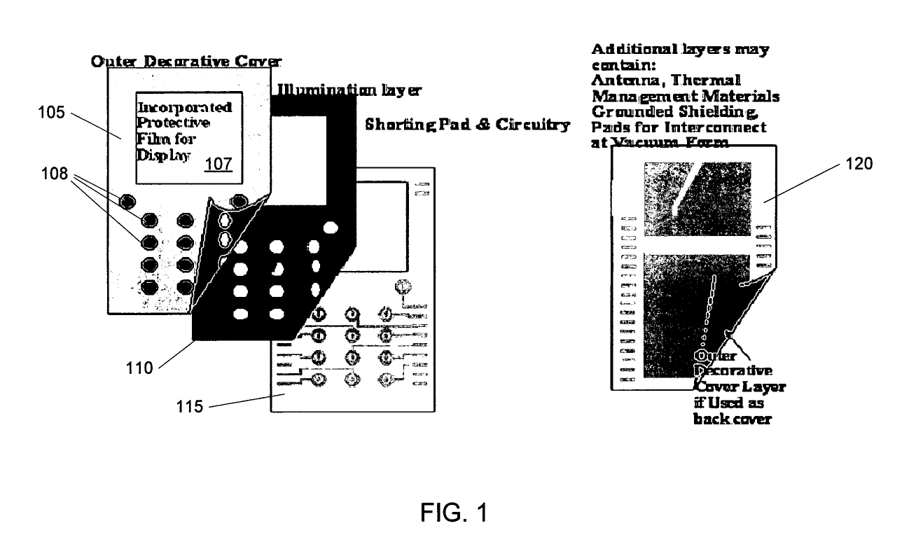

FIG. 1 illustrates multiple layers of a mobile communication device according to an illustrative embodiment. The multiple layers include a front outer cover 105, an illumination layer 110, a circuitry layer 115 and a back outer cover 120. Each layer serves various purposes in the overall operation of the mobile device. For example, the front outer cover 105 may provide decorations or aesthetic features to appeal to consumers. In addition, the front outer cover 105 includes several buttons 108 for user input and interaction with the mobile device. Other input devices may also be implemented including a scroll wheel and a joystick. Each button 108 is composed of a translucent material, allowing a light to illuminate the buttons 108. A transparent protective layer 107 is integrated into the front outer cover 105 for protecting an underlying display screen (not shown). The transparent protective layer 107 consists of a plastic film, a hard plastic or glass screen or other type of material that is sufficiently transparent to allow a user to view the underlying display screen. Each layer is further constructed using cooperating shapes so that the layers may be mated by applying the layers on top of one another and aligning the corresponding edges or other features of each layer. For example, front outer cover 105 is formed in a rectangular shape and having transparent protective layer 107 located at one end. Circuit layer 115 is formed in the same configuration as outer cover 105 including a display region, corresponding to transparent protective layer 107, to which an LCD display may be attached and with a rectangular shape of similar dimensions. Front outer cover 105 may then be attached or mated to circuit layer 115 by aligning transparent protective layer 107 with the display region of circuitry layer 115, and by aligning the outer edges of the two layers 105 and 115.

The circuitry layer 115 provides the electrical connections and signal paths for detecting and receiving user input from the user interfaces of outer covers 105 and 120 and for performing various other functions. The circuitry layer 115 may be double-sided to conserve space and/or to enhance functionality. The circuits of circuitry layer 115 include contact points for the buttons and other input devices that are integrated into the outer covers 105 and 120. As such, the layout of the circuitry layer 115 corresponds to the layout of the outer covers 105 and 120. For example, the circuitry for buttons 108 on the front outer cover 105 is situated in the same configuration and locations as the buttons 108 themselves. Thus, once front cover 105 has been aligned and mated with circuitry layer 115, buttons 108 are also aligned with their corresponding circuitry. More particularly, pressing a button 108 initiates contact with the underlying circuitry at the proper points. The electrical contacts and circuits are further connected to other systems and/or processing units such as a lighting system. A lighting system includes one or more light emitting sources (e.g., an LED, not shown in FIG. 1) and activates upon detection of a predefined event. For example, buttons 108 and/or a display screen may be illuminated upon detecting user input or an incoming call. The light emitting system may also include multiple light emitting sources for enhancing the brightness of illumination or to provide light of varying wavelengths. Other types of lighting sources may include other types of LEDs, lasers, incandescent sources, fluorescent lighting systems or an optical fiber source. For example, an optical fiber light source may be constructed from carbon nano-fibers which, when charged with a voltage, emit light. The carbon nano-fibers may further be encapsulated and integrated into a flexible lightguide. A lighting source such as an LED may be constructed as a separate component and later attached to the circuit board. In some alternative embodiments, however, organic LEDs, thin film transistors (TFTs) or other light emitting sources may be printed directly on illumination layer 110 or circuitry layer 115. Methods of printing light sources on a printed wiring board (PWB) or flexible films include ink jet printing and screen printing. Printing technologies allow p-n junctions to be printed in a very thin line and encapsulated to create a light emitting fiber. Modifications to the encapsulation of a light emitting source such as cuts, abrasions and molded structures may further define areas and directions of light emission.

Illumination layer 110 provides a conduit for distributing light emitted from a lighting source (e.g., an LED) to one or more components of the mobile device. Illumination layer 110 provides a lightguide that channels the light through a predefined planes defined by illumination layer 110. In addition to providing a conduit for light generated by an internal source (e.g., an LED inside the mobile device), illumination layer 110 may also act as a lightguide for external light sources such as natural light (i.e., sunlight). Illumination layer 110 is constructed of a flexible material such as a polymer film or acrylic, silicone and urethane resins. Other flexible materials able to reflect and/or otherwise direct light may also be used. The material may further be selected based on the application of the device and/or on the material's transparency to particular wavelengths of light and refractive index. Other material considerations may include tear strength, dimensional stability, processability and moisture absorption rates. For example, processability may determine how easily optical density modifications may be performed when forming and/or creating the lightguide. Multiple materials may be used in combination when creating the lightguide so as to adapt to certain purposes in one area and for other functions in other areas.

Illumination layer 110 is further characterized by illuminated regions and non-illuminated regions. In areas where illumination is needed, illumination layer 110 may diffract or otherwise manipulate light so that the light is emitted from the layer in a particular direction. In areas where illumination is unnecessary, however, light is prevented from escaping the lightguide by eliminating light diffraction or escape structures. For example, illumination layer 110 provides illuminated areas corresponding to each of a plurality of illuminated components (e.g., input buttons 108) of the front cover 105. In the areas where the front cover 105 does not have an illuminating component, light is prevented from escaping the corresponding region of illumination layer 110. One method for illuminating specified regions of a device is to permit light to disperse out of a predefined plane. Another method of illuminating a particular area is to provide various light manipulation structures within the lightguide for redirecting or otherwise manipulating light from a light source. Such light manipulation structures may disrupt the internal reflection of the lightguide, causing the light to be emitted in one particular area. Light manipulation structures are described in more detail below.

The illumination layer 110 may be formed from (or include) one or more materials having adhesive characteristics for bonding with the circuitry layer 115 and/or mating with the outer cover 105. In one example, the illumination layer 110 may include an adhesive film that bonds the illumination layer 110 to the various other layers. In another example, the illumination layer 110 may implement a liquid adhesive in order to conform to the various components. The liquid adhesive may be applied directly on a mating surface in liquid form and allowed to harden and mold to any structures (i.e., protrusions or recesses) of the surface. More specifically, illumination layer 110 may be installed in an unhardened (e.g., liquid) form and subsequently dried and hardened such that it bonds to sticks to layers 105 and 115. The adhesives may be optically transparent so that the channeling or emission of light is not obstructed. The illumination layer 110 may be used to bond or attach various components and layers and is not limited to the configuration shown. Additionally, the flexibility of the illumination layer 110 allows for the channeling of light to various components that are not directly in a light's path. The lightguide may also bend light around multiple edges of an electronic device in order to illuminate components on both a front and back side of the device using a single light source. The flexibility of the illumination layer 110 and the redirection and/or modification of light will be discussed in further detail below.

FIG. 1 shows only some of the components in a mobile phone. Other components may include an antenna, thermal management materials, grounded shielding and pads for interconnects. The lightguide may also be used to illuminate these components and/or portions thereof. For example, illumination layer 110 or lightguide of a mobile telephone may, upon receipt of an incoming call, direct light to illuminate a translucent antenna. Illumination layer 110 may provide illumination for multiple components of an electronic assembly from a single light source. In another example, illumination layer 110 may illuminate a display screen on the front cover of a mobile phone, the antenna of the mobile phone and an indicator light on the back cover of the mobile phone using a single light source.

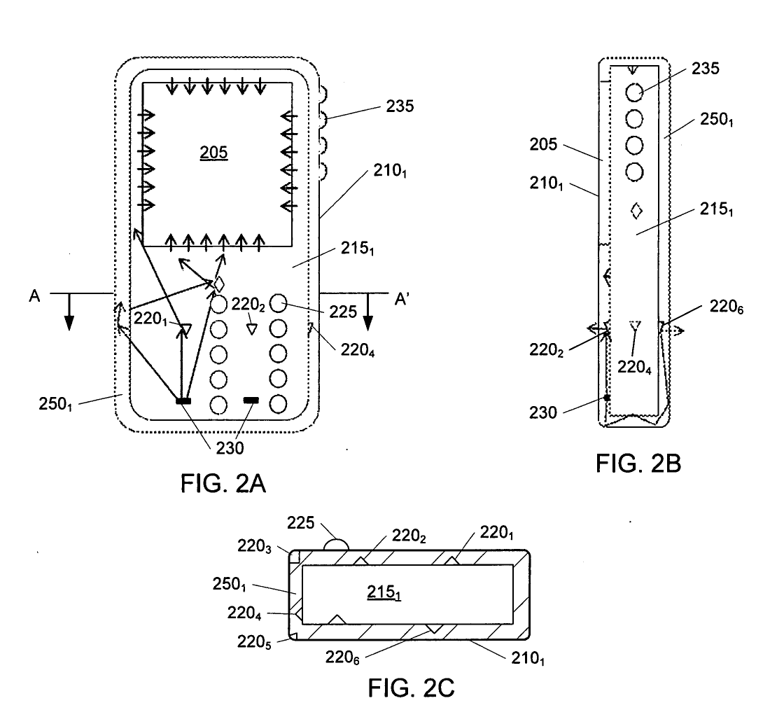

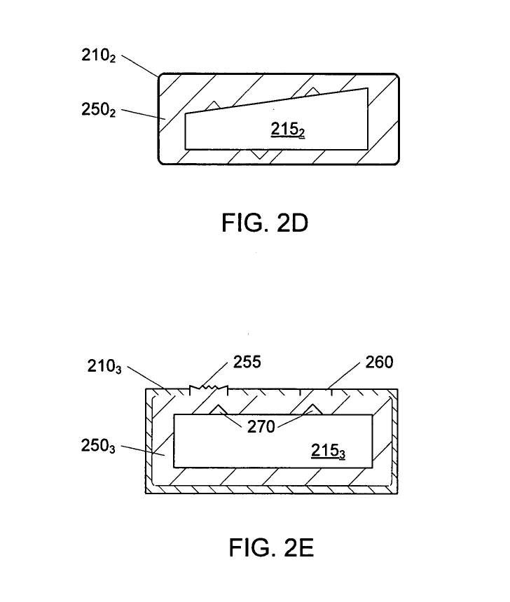

FIGS. 2A, 2B and 2C illustrate multiple schematic views of a mobile communication device according to an illustrative embodiment. FIG. 2A is a front view of a mobile communication device and FIG. 2B is a side view of the mobile device. FIG. 2C is a cross-sectional view taken from the location A-A′ in FIG. 2A and rotated by 180°. The device may be a mobile phone as shown in FIG. 1 or another type of communication device such as a PDA or portable computing device. The mobile communication device illustrated in FIGS. 2A, 2B and 2C includes an outer casing 210₁, a chassis assembly 215₁ and a display screen 205. The outer casing 210₁ includes several components including input buttons 225 and 235 and one or more indicators (not shown). The input buttons 225 and 235 allow a user to interact with the device in a multitude of ways including entering data, increasing/decreasing volume and adjusting the brightness of the display screen 205. The display screen 205 is mated to one or more components of the chassis assembly 215, and secured in place by the outer casing 210₁. The outer casing 210₁ may further include a transparent viewing window corresponding to the display screen 205.

The chassis assembly 215₁ includes several components such as a circuit board and a processor component. Chassis assembly 215₁ further includes light manipulation structures 220₁, 220₂, 220₄ and 220₆ that aid in directing or filtering an emitted light from one or more light emitting sources 230. The light emitting sources 230 are often manufactured separately and attached to the chassis 215₁ in a variety of ways. Alternatively, the light emitting sources 230 may be directly printed on a circuit board layer of the chassis assembly 215₁ using the techniques described previously.

Referring to FIG. 2B, light emitted from one or more of light emitting sources 230 may be directed around a bend in lightguide 250₁ using solely the lightguide through total internal reflection. Total internal reflection is achieved when light strikes a boundary layer, defined by two adjoining mediums, at an angle of incidence greater than a threshold critical angle. The threshold critical angle is based on the refractive indices of the adjoining mediums and may be calculated using Snell's Law. Thus, a boundary layer, formed between the exterior surface of lightguide 250₁ and air surrounding lightguide 250₁, allows a ray of light emitted from light source 230 to reflect around the chassis assembly 215₁ using total internal reflection. In one example, a mobile device may have an illuminating keypad on both the front and rear surfaces. In order to illuminate both keypads, light from an emitting source on the front surface may be reflected around the side or bottom edges using total internal reflection to illuminate the keypad on the rear surface. Thus, a single non-rigid flexible lightguide may bend and guide light around multiple edges and/or planes to illuminate components residing on multiple different surfaces. The bend angle and of lightguide 250₁ may also affect the reflective and transmission potential of lightguide 250₁. In particular, reducing the bend angle of lightguide 250₁ may reduce the total internal reflection achieved due to incompatible angles of incidences, increased light attenuation, breakage and other factors. Non-rigid lightguide 250₁ is sufficiently flexible to adapt its bend angle according to the illumination requirements and physical configurations of underlying chassis assembly 215₁. As such, an optimal bending angle may be determined which optimizes the retention of light while allowing the most flexibility in adapting to physical requirements of underlying chassis assembly 215₁. The optical density of portions of lightguide 250₁ may further be altered to modify the refractive index of a particular section of lightguide 250₁. The modification to the refractive index provides appropriate adjustment of a ray of light's angle of incidence to achieve total internal reflection.

In one or more configurations, light manipulation structures 220₁, 220₂, 220₃, 220₄ 220₅ and 220₆ may also be used to aid in the direction of light through the lightguide. These structures 220₁, 220₂, 220₃, 220₄ 220₅ and 220₆ may include reflective components, optical filters and refractive and diffraction structures. Refraction structures or devices may be used to bend or redirect light in a desired direction while diffraction structures may be implemented to separate light of different wavelengths. In one example, multiple light manipulation structures 220₂, 220₃, 220₄ and 220₅ are implemented to direct light around corners or edges of the chassis assembly 215₁ to illuminate components on other surfaces of the device. The multiple manipulation structures 220₂, 220₃, 220₄ and 220₅ of FIG. 2C are used to direct a light from a light source on the front of the device to the rear. For example, a light source located on a front side of the device may initially emit a light toward manipulation structure 220₂. Structure 220₂ then directs the light to structure 220₃ which, in turn, directs the light toward structure 220₄ and so on, until the light reaches the desired area or component. Light manipulation structures 220₃ and 220₅ may be integrated into the interior surface of outer casing 210₁ or embedded in non-rigid lightguide 250₁ to aid in guiding the light around edges of device chassis 215₁.

The chassis assembly 215₁ or components thereof may have various protrusions or recesses or other surface irregularities on a mating surface, i.e., the surface of chassis 215₁, to which a lightguide will connect or abut. The mating surface is the portion of the chassis assembly 215₁ to which a lightguide may be attached or connected. A flexible and moldable lightguide may be formed to fill the recesses and to adapt or conform to the surface irregularities on the mating surface. Lightguide 250₁ is illustrated as filling the space between the device chassis 215₁ and the outer casing 210₁. By filling the space, the lightguide is further able to dampen vibrations. Additionally, protruding structures, such as a light manipulation component, of the chassis assembly 215₁ may be coupled to lightguide 250₁, thereby becoming embedded in guide 250₁.

Although lightguide 250₁, alone, is able to guide light around a corner or edge, such structures may be used to redirect, modify or otherwise manipulate light as needed. The various manipulation structures 220₁, 220₂, 220₃, 220₄, 220₅ and 220₆ may also be tuned to achieve a desired brightness output based on distance and brightness requirements. For example, a display screen may require greater brightness than an illuminated keypad. Thus, a manipulation structure may be appropriately tuned to provide the required brightness for the display screen. Manipulation structures 220₁, 220₂, 220₃, 220₄, 220₅ and 220₆ may be tuned in many ways such as modifying the surface of the material, changing the optical density of the lightguide materials (i.e., to alter the refractive index), embossing the lightguide and various applying physical manipulations. The surface of the lightguide material may be cut, scratched and molded to vary the manipulative (e.g., diffraction, reflection, refraction) effects of the material. Additionally, the optical density and refractive index of the lightguide may be modified by localized cure techniques using ultra-violet, laser, e-beam or other focused light methods. Light manipulation structures 220₁, 220₂, 220₃, 220₄, 220₅ and 220₆ may be separate structures or devices that are embedded into a lightguide or, alternatively, may be structures created within the lightguide, itself, using techniques such as altering the optical density and refractive index of a particular region of the lightguide.

FIGS. 2D and 2E illustrate cross-sections of alternative embodiments of the electronic device shown in 2A. In FIG. 2D, chassis assembly 215₂ is sloped. As such, lightguide 250₂ is varied in depth in order to achieve a level surface for the electronic device. More specifically, lightguide 250₂ compensates for the difference in depths by filling in the additional space between chassis assembly 215₂ and outer casing 210₂. Lightguide 250₂ may also be molded in a variety of shapes and dimensions in order to conform to various outer casings (e.g., casing 210₂) having different aesthetic or functional designs. In one example, outer casing 210₂ may include several curved surfaces to enhance ergonomics while chassis assembly 215₂ remains a rectangular shape. Non-rigid lightguide 250₂ may thus be implemented to fill the space between chassis assembly 215₂ and outer casing 210₂. A moldable non-rigid lightguide 250₂ may further act as filler material between outer case 210₂ and chassis assembly 215₂ to reduce vibrations and cushion internal components from the effects of impact.

A moldable non-rigid lightguide 250₃ may also create surface features such as grip or tactile components as well as light emitting structures as illustrated in FIG. 2E. Grip structure 255 is provided so that a user is able to handle or use the device more securely. Lighting structure 260, on the other hand, is provided to eliminate the need to manufacture an indicator light as part of the outer casing 210₃. The indicator light may be useful in informing a user of a particular event or condition. Lighting structure 260 and grip structure 255 extend out from the interior of the device through one or more openings in casing 210₃. In one or more alternative embodiments, the lighting structure 260 may provide light or illumination to one or more adjacent structures of the outer casing 210₃ as well. Outer casing 210₃ is manufactured with a predefined thickness that results in an exterior surface flush with lighting structure 260 and ergonomically shaped with respect to tactile component 255. For example, the thickness of outer casing 210₃ may be defined by and correspond to the dimensions (i.e., depth or thickness) of tactile component 255 or lighting device 260.

Lighting structure 260 may serve as an indicator light or some other functional or aesthetic purpose. Additionally, light manipulation structures 270 are integrated into the chassis 215₃ to direct an emitted light toward the illuminating components such as lighting structure 260 and grip structure 255.

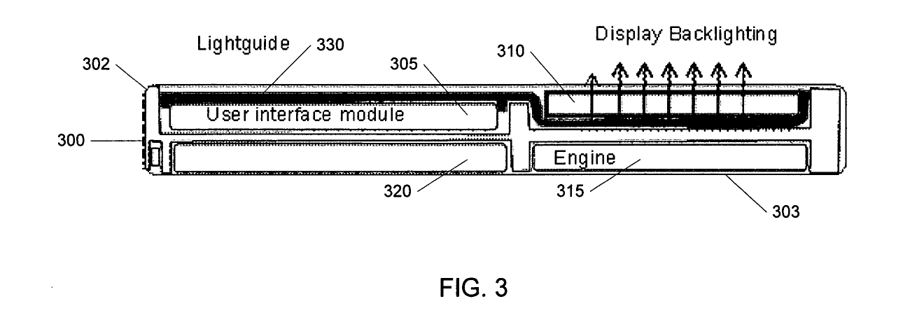

FIG. 3 illustrates a side view of electronic device 300 implementing a lightguide to illuminate multiple components of device 300 according to another illustrative embodiment. Electronic device 300 may be one of any number of devices including mobile phones, PDAs, remote controls and the like. Device 300 includes chassis 302, user interface module (e.g., electrical contacts for input buttons and/or a supporting substructure) 305, display screen 310, processing engine (e.g., a processor and other electronic components) 315, battery 320 and outer casing 303. An input button layer (not shown) may exist between outer casing 303 and user interface module 305. The input button layer may include raised buttons that extend through holes in outer casing 303, allowing a user to enter data into the device. User interface module 305 may detect the depression of the buttons and transmit communication signals corresponding to the pressed buttons. Chassis 302 and outer casing 303 are generally constructed in a shape or design suitable to accommodate the various components 305, 310, 315 and 320 of the electronic device 300. Additionally, one or more light emitting sources (not shown) may be located on the chassis 302 or integrated with the other components 305, 310, 315 and 320 of the device 300. The light emitting source is used to illuminate the one or more input buttons (not shown) and the display screen 310 in certain situations. Numerous other components may also be integrated in electronic device 300 and illuminated by the light emitting source. The outer casing 303 contains and secures the components of the device as well as provides aesthetic and/or functional (e.g., keypad) features.

In one or more alternative embodiments, components 305, 310, 315 and 320 of device 300 may require illumination from a specific direction. For example, display 310 is backlit by emitting a light from the interior side of the display outward toward a viewing user. To provide the proper lighting for display 310, a portion of lightguide 330 is placed along the interior side of display 310. A second portion of lightguide 330 is then wrapped around and conformed to a surface of user input module 305 to provide illumination to one or more corresponding input buttons. Non-rigid lightguide 330 is thus able to conform or adapt to the positional and/or directional lighting requirements of multiple components of device 300. In addition, a non-rigid lightguide 330 may further conform to differing configurations (e.g., placement, size) of the various internal components 305, 310, 315 and 320 of the electronic assembly. FIG. 3, in particular, shows lightguide 330 transitioning from one horizontal plane to another horizontal plane in order to provide proper backlighting for the display unit 310. Without such a non-rigid flexible lightguide 330, additional manufacturing and/or assembly time may be required in order to adapt a rigid lightguide to any variations in the dimensions of the components or of device 300, itself. Additionally, lightguide 330 may fill gaps between the chassis 302 and modules 305, 310, 315 and 320 to provide vibration dampening and to serve as a locking mechanism for holding modules 305, 310, 315 and 320 in place. Electrical circuitry, conductive features or interconnections and other assembly structures may further be integrated with lightguide 330. These components may be printed on or embedded in lightguide 330. Examples of such components may include sensor networks, antennas, shielding or RF absorbing materials, scratch resistant films and charged coupled devices (CCD) and other types of sensor devices.

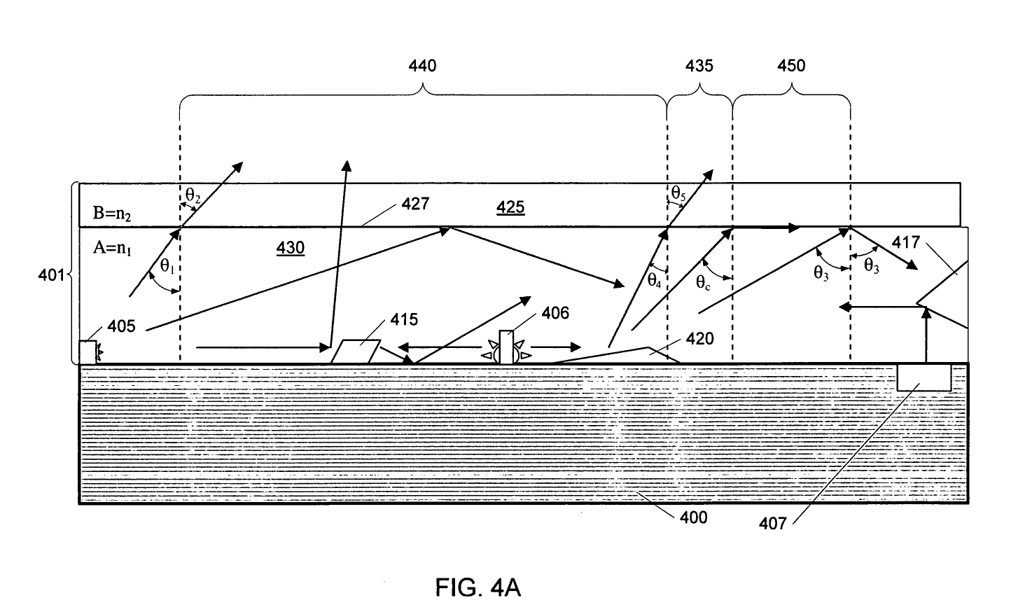

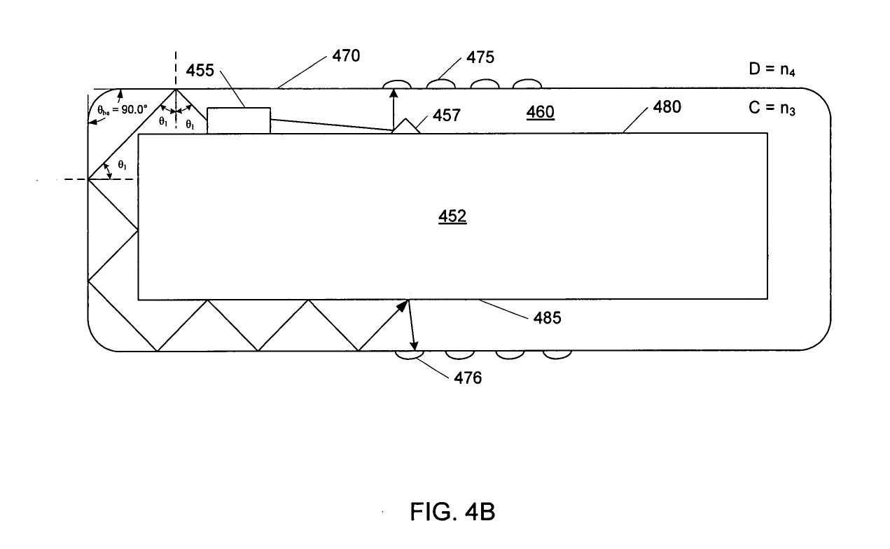

In FIG. 4A, lightguide 401 is composed of multiple layers such as layers 425 and 430, each composed of a different material with different properties (e.g., optical density).

For example, layer 430 may consist of material A having refractive index n₁, while layer 425 may be formed from material B having a refractive index n₂. The use of differing materials such as materials A and B having different properties provides one method for lightguide 401 to target and illuminate specific areas or regions of the device. Device chassis 400 includes light emitting structures such as light emitting diodes 405 and 406 and vertical cavity surface emitting laser (VCEL) 407 as well as multiple light manipulation structures 415, 420 and 417. The use of multiple light emitting structures such as structures 405 and 406 allows the device to illuminate certain portions of the device at certain times while leaving other areas unilluminated.

For example, when an incoming call is received, the device may illuminate an antenna (not shown) while leaving a keypad and/or other components (also not shown) unilluminated. Similarly, if a user is placing a call using the keypad, the device may illuminate the keypad but not the antenna. Light manipulation components 415 and 420 are used to alter the angle of incidence with which light attempts to escape lightguide 401 or a layer 430 or 425 thereof. Depending on the refractive indices and densities of layers 425 and 430, light may or may not be emitted through boundary 427 between layers 425 and 430. Boundary 427 formed by layers 425 and 430 serves to regulate the emission of light in accordance with a design of the device.

Lightguide 401 includes three regions 440, 435 and 450, each providing different lighting conditions. Region 440, for example, is only subject to illumination by light source 405 while region 435 is only illuminated by light source 406. Region 450, on the other hand, is not illuminated by either source 405 or source 406. The difference in illumination of these regions is based on the angle of incidence with which rays of light from either source 405 or 406 hits boundary 427 within each of the regions 440, 435 and 450. The refractive indices of layers 425 and 430 define a threshold critical angle, above which, total internal reflection occurs. More specifically, when a ray of light hits boundary 427, depending on the angle of incidence of the ray, a first portion of the light may be transmitted into the second medium or layer while a second portion is reflected back into the first medium or layer. The angle of incidence refers to the angle between a light ray and the normal (i.e., line perpendicular to the surface of the medium/material) as it leaves a medium. In one or more configurations, total internal reflectance may be used to guide and/or bend light from one surface to another, as is discussed in further detail below.

The amount of light that is transmitted to the second medium versus the amount of light that is reflected is determined by the angle of incidence. The greater the angle of incidence, the greater the portion or amount of light that is reflected. Thus, varying the angle of incidence will also vary the brightness of emitted light (i.e., light transmitted to the second layer/medium). When the optical density of a destination medium or layer (i.e., layer 430) is less than the optical density of an originating medium or layer (i.e., layer 425), light hitting boundary 427 with an angle of incidence greater than the critical angle would be entirely reflected. Using this technique, lightguide 401 may prevent light from being emitted through particular regions by increasing the angle of incidence of light hitting boundary 427 in the specified areas above the critical angle.

In one example, the refractive indices of layers 425 and 430 define a boundary 427 having a critical angle of 45°. Thus, light having an angle of incidence greater than this critical angle, such as angle θ₃, would be entirely reflected back into layer 430 and prevented from escaping. The reflected ray of light would have an angle of reflection (i.e., the angle between the reflected light and the normal) equal to the angle of incidence. If, however, a ray of light hits the boundary 427 at an angle of incidence less than the 45° critical angle, such as angles θ₁ and θ₄, the light would be, at least in part, transmitted into layer 425. Upon leaving layer 430 and entering layer 425, the light ray would be refracted and defined by an angle of refraction such as angle θ₂ or θ₅. Manipulation structures 415 and 420 may be used to modify the angles of incidence of various light rays to either allow a ray of light to escape or to prevent the light from leaving the medium. These structures 415 and 420 may be placed according to the design of the device to allow illumination in some areas of a device while preventing illumination in others. Light manipulation structures 415 and 420 may further be used to vary the degree of brightness of the emitted light.

Applying the illustration to the previous example of illuminating a keypad and antenna at different times, region 435 may correspond to the antenna while region 440 may correspond to the keypad. When a user is using the keypad, light source 405 is activated and illuminates region 440 with the help of manipulation structure 415. Manipulation structure 415 alters the angle of incidence of some light rays whose angles of incidence are too high or too low to cross boundary 427 (i.e., escape layer 430 and enter layer 425). Additionally, light rays from source 405 that reach antenna region 435 are prevented from escaping region 435 by increasing the light rays' angle of incidence above the critical angle. Thus, the antenna remains unilluminated. However, if an incoming call is received, source 406 may be activated, illuminating region 435 using light manipulation component 420. In this instance, light may be prevented from illuminating region 440. The shape, density and other characteristics of manipulation structure 415 aids in modifying the angle of incidence of light from source 405 that might otherwise be able to escape through region 440.

FIG. 4B illustrates the redirection of light from front surface 480 to rear surface 485 around multiple edges of chassis assembly 452 using lightguide 460. In accordance with the principles of total internal reflection, light source 455 emits a light striking boundary 470 with an angle of incidence θ₁ that is less than the critical threshold angle defined by the refractive indices, n₃ and n₄, of lightguide 460 and the surrounding medium (i.e., air). Lightguide 460 is composed of material C having a refractive index n₃ while medium D (air) has a refractive index of n₄. Based on the two refractive indices, n₃ and n₄, a critical threshold angle is determined. Since θ₁ is greater than the critical threshold angle, the emitted light is reflected entirely back into the lightguide at an angle equal to the angle of incidence, θ₁. Accordingly, the light is continuously reflected between the two walls of lightguide 460 around the edges of chassis assembly 452 reaching the other side of chassis assembly 452. Thus, in one example, light source 455 illuminates both a front keypad 475 as well as a rear keypad 476 using total internal reflection. Modifying a bending angle, θ_{ba}, of lightguide 460 may further affect total internal reflection. In particular, by reducing the bending angle, θ_{ba}, of lightguide 460, the angle of incidence with which a light ray strikes one or more boundaries such as boundary 470 of lightguide 460 may be reduced such that the angle of incidence is no longer sufficient to achieve total internal reflection. As such, an optimal bending angle lightguide 460 may be determined to maximize efficiency in the lightguide system. In order to alter the angle of incidence at a specific portion of lightguide 460 (and to allow light to escape boundary 470), the optical density of lightguide 460 may also be changed at the specified point. The optical density, in turn, affects the refractive index of the specified portion of lightguide 460 which adjusts the angle of incidence of light accordingly. Alternatively or additionally, one or more refractive structures such as structure 457 may be used to modify the angle of incidence to allow light to be emitted.

Various methods for altering the angle of incidence of light may also be implemented to ensure total internal reflection and guidance of light around one or more edges of lightguide 460 and/or chassis assembly 452. In one or more configurations, the position of light source 455 may also be adjusted in order to achieve a desired reflection path and effect. Various types of filters may also be used to filter out one or more wavelengths or, alternatively, to allow a specific wavelength of light to escape. In other words, the filters may be used to modify the wavelength of emitted light.

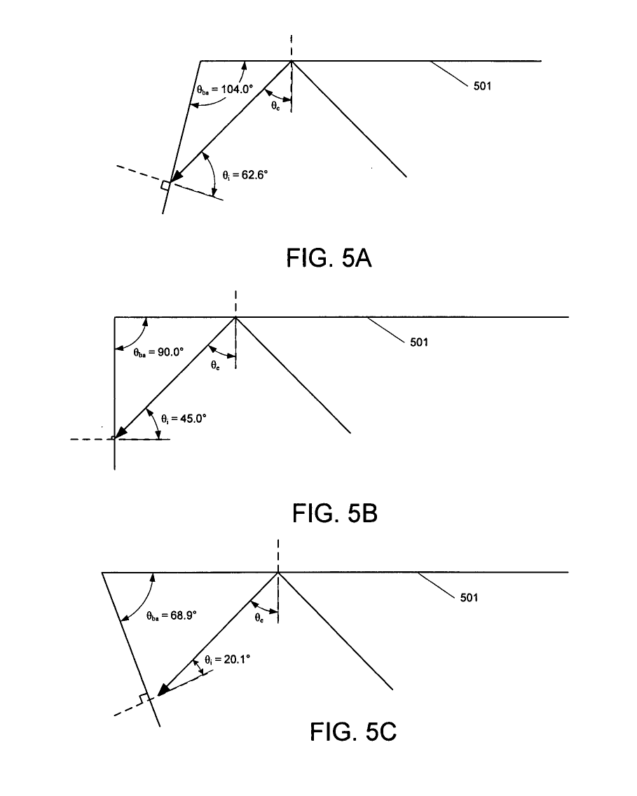

FIGS. 5A, 5B and 5C are diagrams of a portion of lightguide 501 illustrating the effects of varying the bending angle of a lightguide on total internal reflection and the efficiency of the overall lightguide system. Initially, in FIG. 5A, the bending angle of lightguide 501, designated by θ_{ba}, has a value of 104.0°. In FIGS. 5B and 5C, the bending angle of lightguide 501 gradually decreases. For example, the bending angle in FIG. 5B is 90.0° whereas in FIG. 5C, the bending angle is reduced to 65.4° . Each of FIGS. 5A, 5B and 5C further illustrates a ray of light having the same angle of reflectance, θₑ. However, in FIG. 5A, the angle of incidence θ₁ of the light ray is 62.6° while the angle of incidence in FIG. 5B is 45.0°. The angle of incidence, θ₁, further decreases in FIG. 5C, where θ₁ is reduced to 20.1° . As such, by decreasing or reducing the bending angle, θ_{ba}, of a lightguide, the angle of incidence, θ₁, with which a light ray strikes a surface of lightguide 501 is similarly decreased. Significantly, decreasing the bending angle of lightguide 501 from 104.0° to 68.9° may, depending on a variety of factors including the critical angle, eliminate total internal reflection and reduce the overall efficiency of the lightguide system. Accordingly, the modification of the bending angle may also affect the effectiveness of the lightguide in guiding and bending light around corners. An optimal bending angle may be developed based on the critical angle, among other factors, to maximize the reflective efficiency of the lightguide system. Changes to the bending angle of lightguide 501 may also affect the amount of light which is reflected or emitted. By adjusting the bending angle in addition to the size or width of lightguide 501, the intensity of the light may be controlled.

In one or more configurations, a 4 mm thick lightguide may bend 180° while maintaining reflective efficiency within lightguide and the implementing device. Additionally, light may be transferred from a front device surface to a back surface using such a lightguide around consecutive 90° bends. The bending angle may further be used for selectively transferring data and information from one component of a device to another. For example, the bending angle of lightguide 501 may be modified in order to change the refractive angle of a light ray and the ray's destination. Thus, the bending angle of lightguide 501 may be modified to direct a particular source of light to a specified destination component. The wavelength of light may further be altered to reflect different messages. Diffractive structures may also be implemented to achieve the desired destination and/or results.

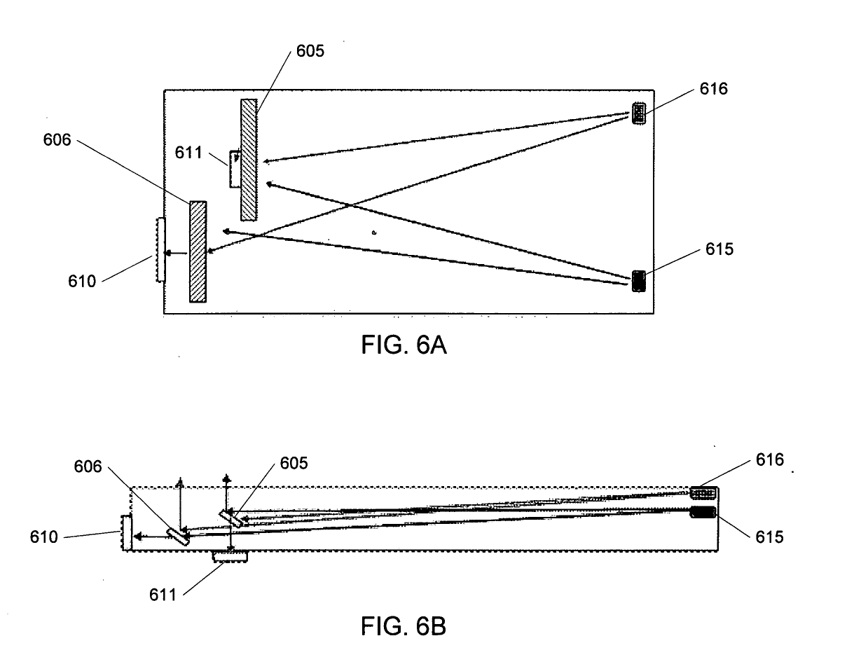

As discussed previously, a lightguide may include several components to filter and channel light to the desired areas. A non-rigid and flexible lightguide may further provide high-speed and concurrent optical communication between multiple sensors at different locations within an electronic assembly. FIGS. 6A and 6B illustrate top and side views of a lightguide that implements multiple optical filters and detection structures according to another embodiment. The lightguide includes several components such as light emitting sources 615 and 616, optical filters 605 and 606 and photodiodes 610 and 611. The optical filters 605 and 606 only allow specified wavelengths of light to pass while blocking or redirecting all other wavelengths. For example, energy from a green LED 616 would pass through one direction of wavelength division multiplexing (WDM) filter 606 while energy from a red LED 615 would be filtered out or blocked by filter 606. Various wavelengths may be redirected by WDM filters 605 and 606 to a particular photodiode such as photodiode 610 or 611 in order to activate a function of the device. For example, a thermostat component of a mobile device may detect that the outside temperature has risen above an appropriate level. The thermostat may then activate, for example, a green LED 616 that passes through a WDM filter 605 which redirects the light to a photodiode 611 associated with a warning system. The warning system associated with photodiode 611 may then activate an audible warning or alarm of the electronic device to alert the mobile device user of the condition. In one embodiment, a detector such as photodiode 610 or photodiode 611 may determine the intensity or brightness of detected light such as sunlight. In response to determining that the intensity of the light is below a certain threshold, signals from one or more of the photodiodes 610 and 611 may cause the display screen to display a specified message to the user. In another embodiment, the lighting conditions of the environment may trigger color changes in the illumination of the electronic assembly or device.

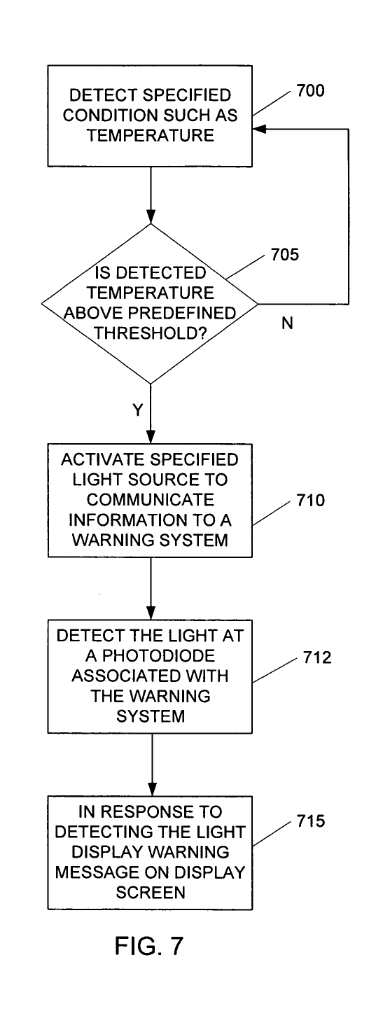

FIG. 7 shows a flowchart illustrating a method for initiating a function in response to detecting a particular wavelength of light. In step 700, an electronic device or a component thereof detects a specified condition such as the outside temperature. In step 705, the device determines whether the detected temperature is above a predetermined threshold. If the temperature is above the threshold, a temperature module activates a light source emitting a particular wavelength of light in order to communicate the temperature information to one or more other systems of the device in step 710. The communication method may correspond to the methods of wavelength filtering and direction as discussed with respect to FIGS. 6A and 6B. Once the light from the light source hits a photodiode associated with a display alert system of the device in step 712, the display alert system may perform a warning function such as display a warning message on the display screen of the device in step 715. Other systems of the device may be initiated in a similar manner simultaneously or according to a specified sequence.

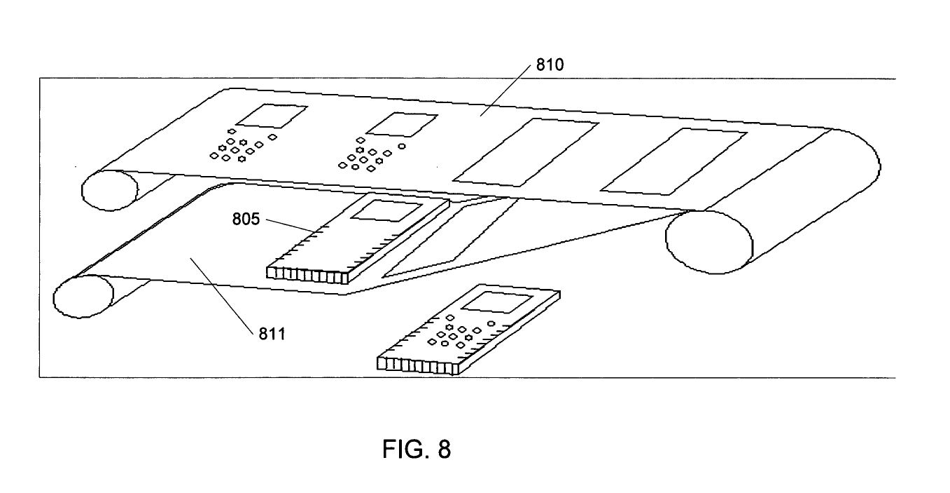

Numerous methods of manufacturing the lightguide may be used when producing a mobile phone or other electronic assembly. These methods include cutting and forming the lightguide from a sheet, additive and subtractive processes using an adhesive film or liquid adhesive, and/or casting and molding manufacturing techniques. Such additive and subtractive processes include patterned etching, dipping and powder coating. FIG. 8 is an example of one process for assembling an electronic device having a flexible non-rigid lightguide according to an illustrative embodiment. In FIG. 8, an assembly chassis 805 is illustrated with two sheets 810 and 811 of a flexible lightguide material. The lightguide material may be cut or otherwise shaped according to the configurations of the assembly chassis 805 for all the various surfaces of the chassis. Alternatively or additionally, the lightguide may comprise one continuous sheet that encompasses and adapts to multiple surfaces (e.g., front and back) of the electronic assembly. The process of forming and integrating the lightguide further includes bonding the sheets to chassis 805, creating appropriate electric and optical interconnects and forming (or attaching or embedding) lenses, reflective structures, gratings and lightguide channels. In one or more alternative embodiments, particular features corresponding to assembly chassis 805 may be preformed on sheets 810 and 811 prior to applying the lightguide to the chassis 805. In another example, a liquid resin may be applied to one or more surfaces of a chassis of an electronic device. The liquid resin would be able to conform to the particular structures or characteristics of the chassis. The liquid resin may then be processed and cured to a B-stage state to form a flexible lightguide. A B-staged resin is one in which a limited reaction between a resin and a hardener has occurred so that the product is in a semi-cured state. B-staged materials may further facilitate adhesion to cladding layers or other structures as desired. The processing temperatures and cure rates may depend on the resin. B-staged materials may be further processed to a fully cured state once the material has been shaped or formed as desired.

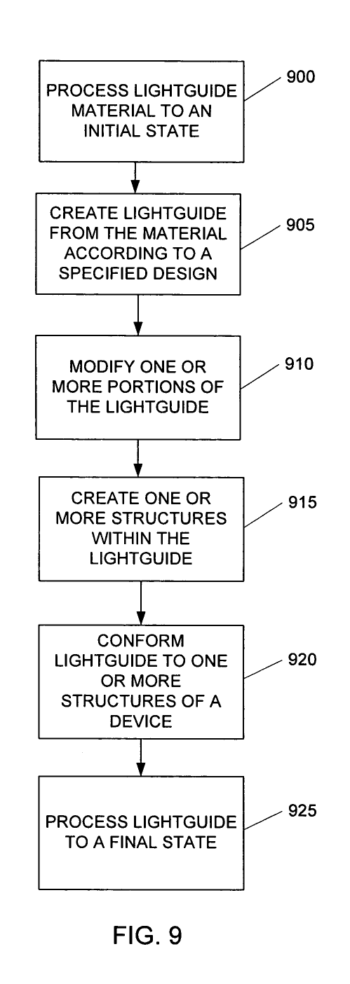

FIG. 9 is a flowchart illustrating a method for manufacturing and assembling the lightguide with a device chassis. In step 900, a material from which the lightguide is to be formed is initially processed to an appropriate initial state. For example, a resin material may be processed to an initial B-staged state so that the material is moldable and conformable. In step 905, the lightguide material is configured or otherwise formed in accordance with the design of a device and the chassis thereof. After the shape and overall design of the lightguide has been finalized, one or more portions of the lightguide may be modified in step 910. Such modification may be performed to alter the densities of certain areas of the lightguide to create regions of varying illumination. Similarly, in step 915, one or more structures may be created in or integrated with the lightguide. In particular, light emitting devices and light manipulation structures, for example, may be created within the lightguide using the methods described previously. In step 920, the lightguide is then conformed to the device chassis as well as to the various features and structures thereof. For example, the lightguide may be used to fill gaps between one or more components of the device and the device chassis to provide vibration dampening. Step 920 may also be performed prior to steps 905-915. In step 925, the lightguide is subsequently processed to a final state. This final processing step may involve fully curing the lightguide to harden the lightguide. Various other assembly or manufacturing steps may also be implemented along with the method described above.

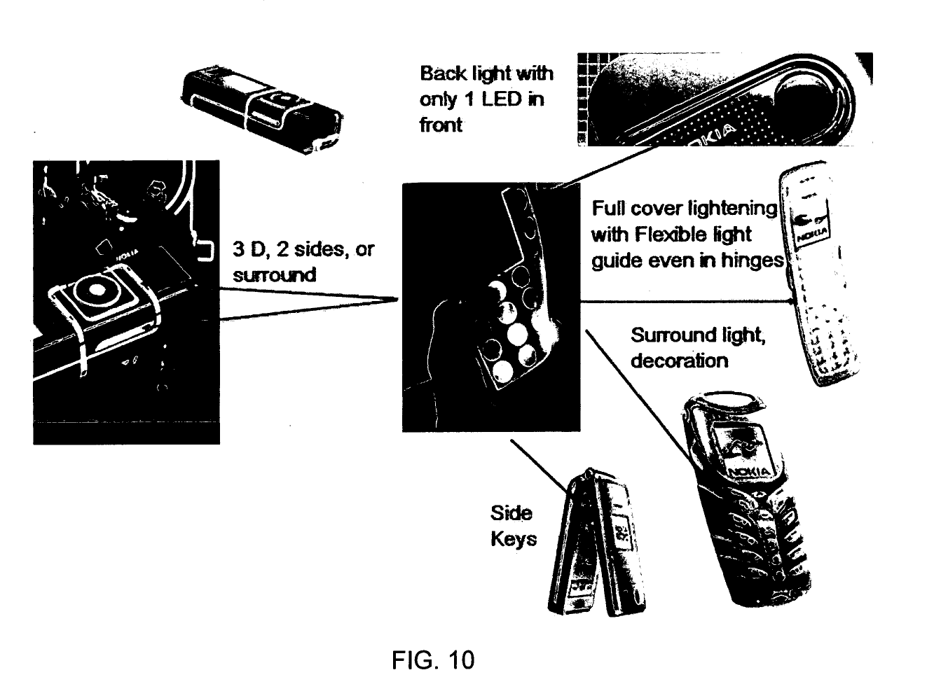

FIG. 10 illustrates a variety of applications and uses of a flexible lightguide. These applications include backlighting one or more components of a device using only a single LED, lighting an entire device cover as well as lighting a components of a device that encompass multiple sides of the device. Input components on the device may also be illuminates using a lightguide regardless of the placement or location of the LED or the input components. The lightguide may further be used in applications that require illumination on any number of sides of a device, for example, in 2D and 3D lighting systems. Thus, a 3D button on a device may be illuminated on more than one surface of the button. In one or more configurations, a lightguide may be integrated into mechanical components like a hinge of a device. As such, the hinges of the device may be illuminated as well. Buttons located on the side of a device may further be illuminated by an LED located on another surface (e.g., the front surface) of the same device.

Several embodiments of the invention have been described. The invention includes numerous embodiments in addition to those specifically described as well as modifications and variations thereof, all of which are within the scope and spirit of the appended claims.

We claim:

1. An electronic assembly comprising:
a light emitting source;
a first surface and a second surface; and
a non-rigid lightguide configured to distribute a light emitted from the light source in one or more directions, wherein the non-rigid lightguide is conformable to a configuration of two or more components of the electronic assembly and wherein the lightguide is further configured to guide the light from the light source from the first surface to the second surface.

2. The assembly of claim 1, wherein the non-rigid lightguide comprises a plurality of layers, wherein each layer of the plurality of layers comprises a material having a different refractive index.

3. The assembly of claim 1, wherein the lightguide comprises a plurality of regions, wherein the plurality of regions are defined by the angles of incidence corresponding to light traveling in each of the plurality of regions.

4. The assembly of claim 3, wherein one or more regions of the plurality of regions comprise one or more light manipulation structures, wherein the light manipulation structures modify the angles of incidence corresponding to light traveling in each of the one or more regions.

5. The assembly of claim 1, wherein the first surface opposes the second surface.

6. The assembly of claim 1, further comprising one or more light manipulation structures integrated with the non-rigid lightguide, wherein the one or more light manipulation structures are configured to manipulate the light emitted from the light source.

7. The assembly of claim 6, wherein the one or more light manipulation structures comprise a refractive structure.

8. The assembly of claim 6, wherein the one or more light manipulation structures comprise a diffractive structure.

9. The assembly of claim 1, wherein the one or more components comprise an optical filter.

10. The assembly of claim 1, wherein the lightguide is molded around the light emitting source.

11. The assembly of claim 1, further comprising one or more light-sensitive detectors, wherein a system associated with the one or more detectors initiates one or more functions in response to the detectors detecting a specified wavelength of light.

12. The assembly of claim 1, wherein the lightguide extends through an outer cover of the assembly.

13. The assembly of claim 1, wherein the lightguide comprises a first portion having a first optical density and a second portion having a second optical density, wherein the first optical density corresponds to a first refractive index and the second density corresponds to a second refractive index.

14. A wireless mobile communication device, comprising:
a display area;
one or more input components;
an illumination component comprising a non-rigid lightguide for providing illumination to the display area and the one or more input components, wherein the non-rigid lightguide is conformable to a configuration of two or more components of the mobile device;
a circuitry layer; and
a light emitting device for emitting a light through the illumination component, wherein the illumination component is further configured to guide the emitted light from a first surface of the device to a second surface of the device.

15. The mobile device of claim 14, wherein the lightguide comprises a first layer of a first optical density and a second layer of a second optical density, wherein the first optical density corresponds to a first refractive index and the second density corresponds to a second refractive index.

16. The mobile device of claim 14, wherein the lightguide comprises a plurality of regions, wherein the plurality of regions are defined by angles of incidence corresponding to light traveling in each of the plurality of regions.

17. The mobile device of claim 16, wherein one or more regions of the plurality of regions comprise one or more light manipulation structures, wherein the light manipulation structures modify the angles of incidence corresponding to light traveling in each of the one or more regions.

18. The mobile device of claim 14, wherein the lightguide comprises a first portion lying in a first plane and a second portion lying in a second plane, wherein the second plane is different from the first plane.

19. The mobile device of claim 14, wherein the flexible non-rigid lightguide further comprises a light manipulation structure configured to manipulate light from the light emitting device.

20. The mobile device of claim 14, flexible non-rigid lightguide further comprises an optical filter.

21. The mobile device of claim 14, wherein the first surface and the second surface include opposing surfaces.

22. A method for assembling an electronic device having one or more illuminating components and a chassis, comprising the steps of:
creating a non-rigid lightguide; and
conforming the non-rigid lightguide to the chassis and one or more components of the electronic device.

23. The method of claim 22, wherein the step of conforming a non-rigid lightguide further comprises molding the lightguide to conform to one or more structures of the chassis.

24. The method of claim 22, wherein the step of conforming a non-rigid lightguide further comprises molding the lightguide to fill gaps between the one or more components and the chassis.

25. The method of claim 22, wherein the one or more components of the electronic device comprises at least one of a display screen, a battery and a processing engine.

26. The method of claim 22, wherein the step of creating a non-rigid lightguide comprises forming a light emitting structure in the lightguide.

27. The method of claim 22, further comprising the step of modifying a optical density of a portion of the lightguide, wherein modifying the optical density of the portion of the lightguide changes the refractive index of the portion of the lightguide.

28. The method of claim 22, wherein the step of creating a non-rigid lightguide comprises processing the lightguide to a B-staged state.

29. The method of claim 22, wherein the step of creating a non-rigid lightguide comprises:
applying a material to the chassis; and
curing said material to form the non-rigid lightguide.

30. A wireless mobile communication device, comprising:
a keypad comprising a plurality of translucent buttons;
an antenna;
a display screen located on a first side of the communication device;
a light emitting device;
a plurality of light manipulation structures;
an illuminating component on a second side of the communication device;
a circuitry layer; and
an illumination layer comprising a flexible non-rigid lightguide, the flexible non-rigid lightguide illuminating the translucent buttons of the keypad, the display screen and the illuminating component by channeling a light from the light emitting device to the keypad, display screen and antenna using one or more of the plurality of light manipulation structures.
